(19) United States
(12) Patent Application Publication
(10) Pub. No.: US 2004/0045009 A1
(43) Pub. Date: Mar. 4, 2004

(54) Observation tool for signal processing components

(75) Inventor: Jeffrey F. Bryant, Londonderry, NH (US)

Correspondence Address: Robert K. Tendler, 65 Atlantic Avenue, Boston, MA, 02110, US

(73) Assignee: BAE SYSTEMS INFORMATION ELECTRONIC SYSTEMS INTEGRATION, INC.

(21) Appl. No.: 10/290,939

(22) Filed: Nov. 8, 2002

Related U.S. Application Data
(60) Provisional application No. 60/406,853, filed on Aug. 29, 2002.

(51) Int. Cl. G06F 9/00

(52) U.S. Cl. 719/316

(57) ABSTRACT

A method for operating a system having a plurality of software components includes an observation tool in the form of a control panel that is first attached to one of the components. The control panel then configures itself based on information derived from the component. The configuration consists of the discovery of all the externally accessible attributes of the component and the properties of the attributes such as name, data type, legal value and the like. The user may then effect changes in the component using this common mechanism. Since components have a common interface, an observation tool may interact with any component.

### FIELD OF THE INVENTION

This invention relates to software architecture, and more particularly to an observation tool for observing the operation of software components in a distributed computing signal processing system.

### BACKGROUND OF THE INVENTION

In distributed computing signal processing systems, a number of software modules are connected together at run time in order to provide a system for accomplishing a particular task or set of tasks to perform an overall function. The compelling reason for creating a system by combining software components or modules is to be able to construct an elaborate system using off-the-shelf components, preferably commercially available. If one can construct the system using interchangeable components, then one can quickly design a system. The problem is however to be able to test the system when it is running and reconfigure it on the fly. One also needs to be able to do this without a deep understanding of the operation of the individual software components, its coding or software or even the underlying software architecture. In short, one needs a very sophisticated observation tool which is self adapting to each of the modules and which can present to the designer what the designer needs to know not only to monitor the running system but also to permit maintenance and some reconfiguration capability.

For an historical perspective, the rapid evolution of technology has posed significant problems, as well as benefits. Some technologies never achieve their full potential while others evolve rapidly, leaving earlier versions obsolete shortly after they have been installed. Technologies may need to be frequently substituted or otherwise adapted to compensate for different needs. Software particularly must be made amenable to substitution and adaptation and can be a means of allowing integration of new hardware or allowing existing hardware to fulfill new functions.

Large-scale software development has evolved rapidly from its inception. Through the 1980s large-scale software was developed in modular systems of subsystems. Even today these are the most common systems in use. These systems are largely hardware dependent, in which problems or errors could be detected down to the level of the subsystem. These systems were based on point solutions where the problem/solution is functionally decomposed into subsystems. In order for these systems to be of maximum use and flexibility, they needed to be designed for reuse in which software modules or components could be interchangeable and replaceable. As a result, potential reuse of the software for other applications must be anticipated during development and integrated into the software design. Extensions of the software are difficult and can only be achieved when such extensions were anticipated and designed into the system architecture itself.

In the 1990s, some improvement came with the advent of Object Oriented Systems (OOS). Object Oriented Systems were still deficient in a number of respects. OOS are still hardware dependent, they are designed for specific hardware configurations and modules are not productized. Off-the-shelf components could not be easily integrated into a software since each piece of software was developed for a particular hardware platform using different languages. Also, no standard interface was available. Moreover, these systems were based, like their predecessors, on point solutions, with the point solutions for OOS derived using Object Oriented Analysis. As it turned out, extension of the system using existing components was difficult as a result of the multiplicity of languages used.

In recent years, research and development has centered on layered or component based systems involving the use of software modules or components. In such a system a thin common layer or component base class is used in the development of all software modules. Each of the major capabilities of the system is represented by at least one module or component. These modules or components are thus “wrapped” in the thin common layer. Independent components are developed, tested, and packaged independently of each other, and while operating have no knowledge of their environment, since all input/output is constrained to interface ports connected from the outside. In such a distributed system, run time discoverable parameter ports control specific behavior of the modules or components.

Component technology has in recent years become an area of increasing interest given the above challenges. Component technologies such as, CORBA, Common Object Request Broker Architecture (developed in 1997), allow for increased flexibility when implementing business processes. By combining components many different software products can be created from existing modules. This increases the speed and efficiency of software development, thereby better meeting client and internal demands and decreasing costs associated with development.

The goal now is to make software components that allow reuse by performing a particular function and providing an appropriate interface with a larger system, with each component being autonomous regarding its particular functionality. This autonomy allows changes to be made with individual components without disturbing the configuration of the entire system. Relating the various quasi-autonomous components to each other results in a high degree of complexity in communication and synchronization code.

A system of reusable and flexible components would be especially useful for developers of large and complex software packages, such as military contractors. In the past, software was designed specifically for a contract. When a new contract was bid for, the contractor stated from scratch. As discussed above, differences in language and architecture prevented different functionalities from being reused from earlier contracts. Since the software was newly developed there remained a relatively high risk of failure in the software or its interfaces. As a result, the new software required testing and packaging, adding to the cost of the contract. The application of a flexible framework of reusable and interchangeable components would enable a client to leverage earlier development investments and minimize risk of failure in the development process. Contractors would be able to provide clients with more accurate and lower bids and possibly prototypes or catalogues of products easily configured to the clients needs.

A similar, though different, architecture is SCA, or Software Communication Architecture. This architecture is used in such applications as SDR (Software Defined Radio) SCA has Specific IDL interfaces defined for software radios. Any new desired capabilities must fit in to pre defined IDL. SCA provides an interface framework; and as such is not hardware independent. While peer-upper layer interfaces are well defined in SCA, lower layer interfaces are largely ignored.

Another disadvantage of SCA for more general application is its total reliance on CORBA layered communications. Such problems present themselves in CPU overhead and quality of service. Messages can be delivered out of order and processed by different threads when belonging to the same data streams. Thus the SCA architecture is unsuitable for the distributed computing application.

Rocray et al. in published U.S. Application Pub. No. US 2002/0065958 A1 disclose a multiprocessor system that comprises a plurality of processor modules, including a software management processor, a non-volatile storage memory configuration (NVS), and a plurality of software components stored on the NVS configured for use in the processor modules. The application further discloses a software generic control information file used by the software management processor to relate the compatibility of software and to determine which of the software components to distribute to a processor module that requires software stored on the NVS.

In published PCT application, WO 02/057886 A2, Talk2 Technologies discloses Methods, systems, and computer program products for dynamically accessing software components in an environment that of processing nodes. In the '886 reference, each node includes one or more software objects, such as one or more software component objects (virtual processors), a controller object, a database object, a trace object, an agent object, etc. Requests for the functionality implemented by a particular software component are load balanced across the available instances. If no software components are available, a request may be submitted to a scheduler. A software component also may be reserved for future processing. Relationships between software components are defined by platform independent logic that is accessible through a database object and processed by a controller object. An agent object tracks which software components are available at the one or more nodes for which the agent is responsible.

In order for such a component system to properly function a central infrastructure must provide a forum for this communication and synchronization for components and control the allocation of the tasks to the various components based on the capabilities and availabilities of those components, thereby preventing conflicts and redundancies.

Clearly what is needed to create a flexible framework of reusable and interchangeable components, developed and working independently, coordinated by controls that can be manipulated without substantial reengineering or programming in runtime.

### SUMMARY OF THE INVENTION

The present invention is an observation tool to enable the developer of the particular system to observe the operation of and set or change parameters for the various components making up the system, and to do so without foreknowledge of the operation of the component. It operation, the tool when connected to a component, queries the component and sets itself based on the results of the query. Thereafter, the tool adapts itself to the characteristics of the module and proceeds to inform the user of the operation of the component in real time. As such, the subject observation tool comprises a maintenance and user interface (which is referred to hereafter as “MAUI”).

This invention thus encompasses an application involving a control panel that can be attached to a component in the system. Once this control panel is attached, it configures itself based on things it discovers from the component. For example, it configures its parameter display based on the parameters that it discovers from the component that are used by the component. It has a plot display for viewing the operation of the component and populates its plot menu based on plots that the component says are available. The observation tool also has a display to display various statistics associated with the component, and populates its statistics based on statistics that the component advertises in its standard API. It queries the component's input ports and output ports and presents a list of each these ports, as well as allowing the user to discover all the context or the attributes of the component.

All of the above observations are accomplished externally using a single common piece of software which is useable for any component in the system regardless of what type of component it is.

One of the other features that the user can do is attach the subject observation tool to any of the connections in the system and capture data in a trace buffer. Once the data has been captured the user can go through it and display it in different formats and record it onto disk for processing by other applications such as MATLAB and other types of analysis tools.

The subject system is non-intrusive in the sense that the user can go non-intrusively through a working system and virtually attach the subject observation tool with its control panel to any connection and capture data. In this sense, the present invention may be compared to taking an oscilloscope probe and connecting it to a pin on an integrated circuit chip to look at the data.

As can be seen, the subject observation tool permits viewing and modifying the parameters associated with a component such as the component's name, type, current value, default value, and both minimum and maximum value. The tool can view and monitor the statistic parameters of the component. It can view plots generated by the component, in which in one embodiment the tool's plot display line contains a folder if the component generates plots. Further, the subject tool permits viewing the details of the component's input and output ports and displays information such as the number of bytes received or transmitted and the data type of the port.

In summary, a method for operating a system having a plurality of software components includes an observation tool in the form of a control panel that is first attached to one of the components. The control panel then configures itself based on information derived from the component. The configuration consists of the discovery of all the externally accessible attributes from the component and their properties such as name, data type, legal value and the like. The user may then effect changes in the component using this common mechanism. Since components have a common interface a single panel may interact with any component.

### BRIEF DESCRIPTION OF THE DRAWINGS

These and other features of the subject invention will be better understood in connection with the Detailed Description in conjunction with the Drawings, of which:

FIG. 1 is a block diagram of a distributed signal processing system illustrating the connection of a framework manger, components, and process manager to a communications fabric to create a flexible and reusable component architecture;

FIG. 2 is a block diagram showing the system of FIG. 1, showing the interconnections of the parts logically rather than all going through the communications fabric;

FIG. 3 is a diagrammatic illustration of a Unified Modeling Language, UML, class diagram for the structure of a component;

FIG. 4 is a UML class diagram for an example simple component called TMP;

FIG. 5 is a UML class diagram showing associations for the simple TMP component;

FIG. 6 is a diagrammatic illustration of the layered architecture of one embodiment of the signal processing system of FIG. 1;

FIG. 7 is a block diagram showing the operation of the subject observation tool and its connection to various components;

FIG. 8 is a schematic diagram drawing showing the external view of a component and all it's interfaces as would be practiced according to a preferred embodiment of the present invention;

FIG. 9 is a view of a computer monitor showing the sender and viewer screens used in a preferred embodiment of the present invention;

FIG. 10 is a view of a computer monitor in which the user selects parameter items according to a preferred embodiment of the present invention;

FIG. 11 is a view of a computer monitor in which Plot Tool parameters are selected and in which a plot is displayed according to a preferred embodiment of the present invention;

FIG. 12 is a view of a computer monitor for controlling a Tasking Server according to a preferred embodiment of the present invention;

FIG. 13 is a view of a computer monitor for controlling a Plan Text Editor according to a preferred embodiment of the present invention;

FIG. 14 is a view of a computer monitor for controlling a tasking server according to a preferred embodiment of the present invention;

FIG. 15 is a view of a computer monitor for a MAUI to specify for a component for a framework sender: parameters, statistics, plots, input ports and output ports according to a preferred embodiment of the present invention;

FIG. 16 is a view of a computer monitor for displaying for an output port the amount of data sent according to a preferred embodiment of the present invention;

FIG. 17 is a view of a computer monitor showing the Task Editor for Task Simpletask (8) according to a preferred embodiment of the present invention;

FIG. 18 is a view of a computer monitor for displaying timestamps, sizes and frequencies of data at an output port according to a preferred embodiment of the present invention; and,

FIG. 19 is a view of a computer monitor showing a Packet Trace Display according to a preferred embodiment of the present invention.

### DETAILED DESCRIPTION

### Description of Distributed Signal Processing System

Prior to describing the subject observation tool, what is now described is a distributed signal processing system involving the use of software components or modules, the operation of which is to be observed. Note that the underlying system has a universal structure to permit plug and play functionality.

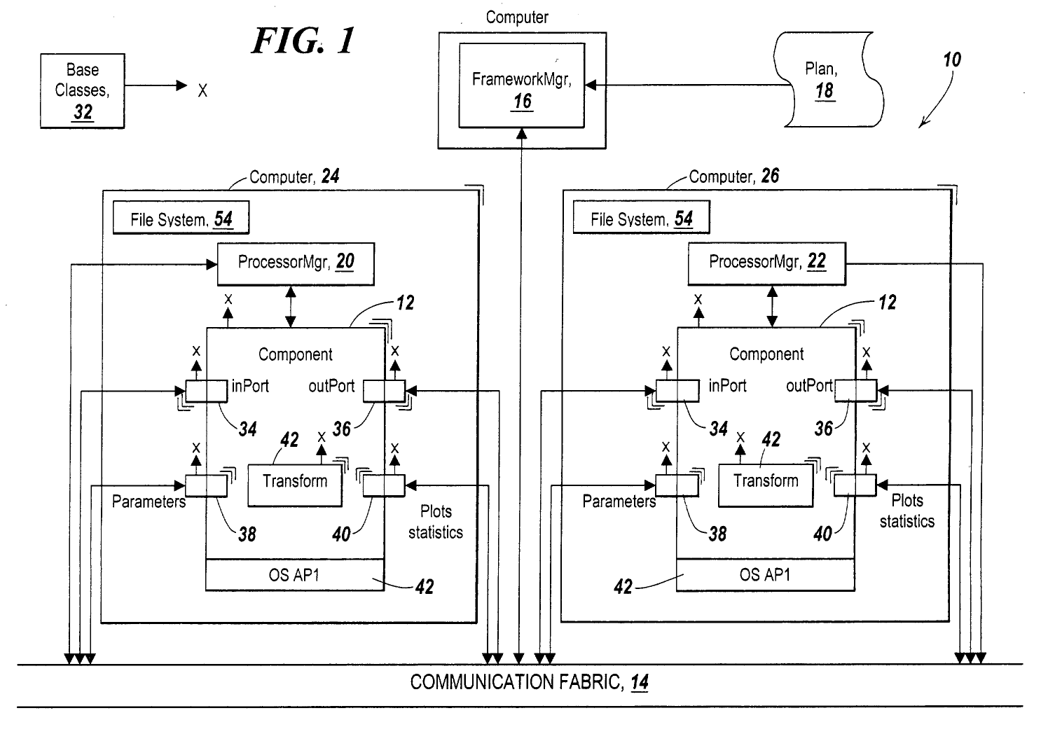

Referring to FIG. 1, in order to provide for a universal framework architecture for signal processing, a system 10 includes a number of components 12 and 13 which are connected through a communication fabric 14 to each other and to a Framework Manager program 16, which is provided with a Plan 18 for defining the system. Each of the components is coupled to a respective Processor Manager program 20 and 22 with the components executing on a number of respective computers 24 and 26, each computer having its associated Processor Manager 20 and 22.

The communication fabric permits communication between the components of the Framework Manager and associated Processor Managers as well as computers so that system can be reconfigured based on Plan 18 read by Framework Manager 16.

It will be noted that each of the components have standardized interfaces, namely an one or more input ports 34, one or more output ports 36, parameters port 38, and a plot port/statistics port 40. These interfaces are managed by objects: an input port object manages the input port interface, an output port object manages the output port interface, a parameters object manages the parameters, and another parameters object manages the statistics interface. Further, a plot object manages the plots interface. Components also include a transform object 42, the purpose of which is to instantiate the particular function that the component is to perform.

Each component has access to the native operating system only by interfacing through the Operating System Application Programming Interface, OSAPI, 42 so that regardless of the particular computer or operating system used, the component operating system interactions are transformed to that of the particular computer and operating system.

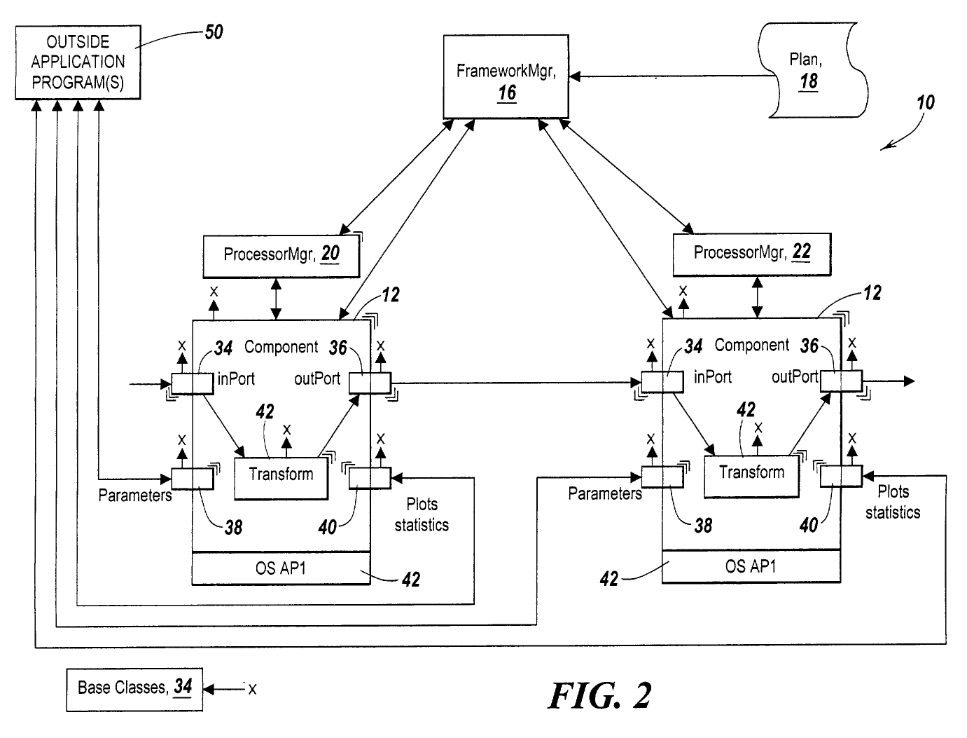

In operation, the system described in FIGS. 1 and 2 operates as follows: For a particular signal processing application a system designer or application engineer first constructs a Plan 18. A Plan is a preformatted file representing a schematic of the configuration of the various components to be used to solve a particular signal processing problem. It defines components, their interconnections and interconnection communication methods, and initial parameters to control component activity. Components may be assigned to particular computers, useful when certain computers have input/output interfaces with particular hardware such as signal digitizers required by the specific component. Optionally, the Framework Manager will assign components to computers at run time. The plan is prepared separately based on tasking for the system.

On system boot-up the Framework Manager is loaded and started. The Framework Manager starts a process thread that monitors requests from Outside Application Programs 50 which seek to task or control the system. Once any outside application sends a message to a pre-defined port, the Framework Manager accepts it and establishes an identity and reference for that application.

As each, computer in the system boots up and comes on-line, the Processor Manager program is loaded and started on each participating computer in the system. Each Processor Manager broadcasts a UDP packet to register with the Framework Manager indicating that it is present and ready to accept components. This message is received by the Framework Manager, which acknowledges each processor manager. As the Framework Manager establishes communications with each Processor Manager it develops a list of all the computers having a Processor Manager. These computers with Processor Managers are the available processing assets.

The Outside Application requests that the Framework Manager load the pre-constructed plan for operation. Typically more than one plan can be in operation at the same time in the same system. In fact multiple plans can share components provided the identities of those are the same in both plans.

The Framework Manager analyzes the Plan and deploys the particular components onto computers 24 and 26 as dictated by the Plan and the available computers. This is accomplished by the Framework Manager passing the name or names of the component or components for that computer to Processor Manager 20 or 22 on that computer. It will be appreciated that one or more of the many processors in the system may have failed and therefore their Processor Manager isn't able to register with the Framework Manager so the plan can be configured around the failure. Each Processor Manager then downloads the requested components for its particular computer. The components then register with the Processor Manager that in turn tells the Framework Manager that the component is loaded. The Framework Manager maintains a list of components and their locations. From time to time, for example every second, the Processor Manager sends a message to each component deployed on its computer to determine whether each component is still functioning normally. Failed components are unregistered and the Processor Manager notifies the Framework Manager that in turn logs the condition and notifies the outside application.

The Processor Manager starts the execution of component 12 and this occurs for each of the components identified in the Plan.

The Framework Manager also analyzes the Plan and identifies the parameters for the particular components. The Framework Manager communicates via parameter interface 38 in setting the parameters for the particular component to the correct default values as identified in Plan 18. Again, this occurs for each component in the Plan.

Next, the Framework Manager analyzes the Plan and identifies the connection or connections between the output ports 36, outPorts, of the components and the input ports 34, inPorts of the components. This connection-based communication mechanism is peculiar to signal processing where streams of data are passed between the components to perform the aggregate system processing required. The Framework Manager looks in its processor list and obtains the identity and reference for the source and destination components. The connection is established between the output port and the input port by the Framework Manager communicating to the output port 36 a list of destinations which are the identities of the input ports on each of the components that are to be connected. To do this the Framework Manager obtains the input port reference from the destination component and the output port reference from the source component. The port types are compared against the Plan to ensure validity. If they are valid, the Framework Manager tells the source component to connect its output port to the input port of the destination component. The output port then sends a message to the input port instructing it to accept data or events from the particular output port. This again is repeated for each connection specified in the Plan. Using this method it is possible for an output to be received by multiple input ports and for a single input port to listen for data or events from more than one output port. Note that these connections are established at runtime. These connections may also be removed and reestablished from one component to other components, hence, making the system reconfigurable at runtime.

Various methods for communication are available within the system and represented by the communication fabric 14. Physical connections, including busses, point to point connections, switched data fabrics, and multiple access networks are abstracted by logical layers in the system so that several logical connection types are available for communication between components. In one embodiment, the default specifies remote object method calls via a real time object request broker, ORB. The ORB complies with the industry standard Common Object Request Broker Architecture, CORBA and is implemented by an off-the-shelf product. This selection is in keeping with the underlying object-oriented architecture of the system, but can be changed. Other communication means include sockets, which are supported by the target operating systems, and the native communications protocols of the switched fabric interconnects being used. One example is GM over Myrinet. The Plan defines the communication type and that type is sent to the ports when the communications are established as defined above.

Finally, when all the deployment and connections are completed, the Framework Manager starts each of the components using the start method on the component interface of each of the components 12. Upon invocation of the start method, the components commence processing any signals or events arriving at the component input port or ports and may output signals or events from output ports.

If the parameters of a component need to be changed, Outside Application Program 50 first needs to determine the available parameters. Via the ORB it calls the component to request definition of its parameters. The component returns the available parameters. The outside application can then call the component to request current parameter values, change the parameter values, or register to be notified when parameters are changed by some other means, ie. another outside application. Then when parameters are modified the component notifies all registered applications of the change. When it is finished the outside application calls the component to unregister for notifications.

### Components

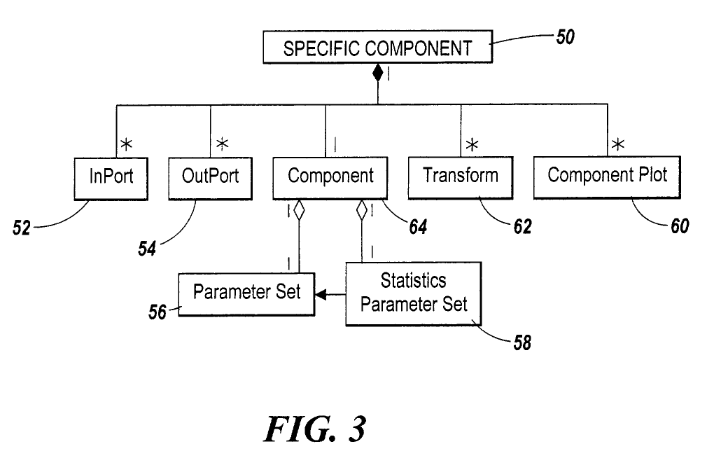

The component, itself an executable program, has required interfaces as shown in FIG. 2, namely an input port 34, an output port 36, parameters 38, plots and statistics 40. These interfaces are managed by objects in one embodiment as shown in the standard Unified Modeling Language, UML, class diagram of FIG. 3. The specific application component 51 has an input port object 52 which manages the input port interface; an output port object 54 which manages the output port interface; a parameterSet object 56 which manages the parameters; a Statistics ParameterSet object 58 which is another ParameterSet that manages the statistics interface; and a ComponentPlot object 60 which manages the plots interface. Components also include a Transform object 62, the purpose of which is to implement the particular function that the component is to perform. The statistics and parameters are part of the Component object 64 which provides control for the overall component.

Each of the components is similar in that it performs a cohesive processing step and meets the same interface. In addition to requiring that each component meet this defined interface the classes that define objects that manage the interfaces, input port class, output port class, parameters class, and plot class, all inherit their underlying capabilities from the corresponding base classes. The base classes provide a guaranteed interface outside the component and provide default useful functionality. This reduces the amount of specialization a particular software developer is required to create in order to have a fully functioning component.

The transform is an object that performs the required signal processing work. These are generally different for each component providing the specialized transformation of data that is done as part of the signal processing. There can be one or many of the transforms in each component.

However, the basic form of each these objects which together form a component, input port, output port, component, transform, parameters, statistics, plots, is the same and they are guaranteed to be compatible with the interface because they inherit from the base classes. The input port base class provides an interface to receive data or events. The component base class provides an interface to the framework and the Processor Manager for identification of the basic control of transforms and the ports. The transform base class provides a simple interface to be used by the component developer. The plotting base class provides engineering and plotting interface used typically for debugging and analyzing problems in the components. Using the plotting interface, arrays or vectors of numbers in the memory of the component may be rendered as signals graphically. The need for this visualization capability is unique to signal processing. The output port, again, provides the means of outputting signals from the component using common mechanisms.

### EXAMPLE

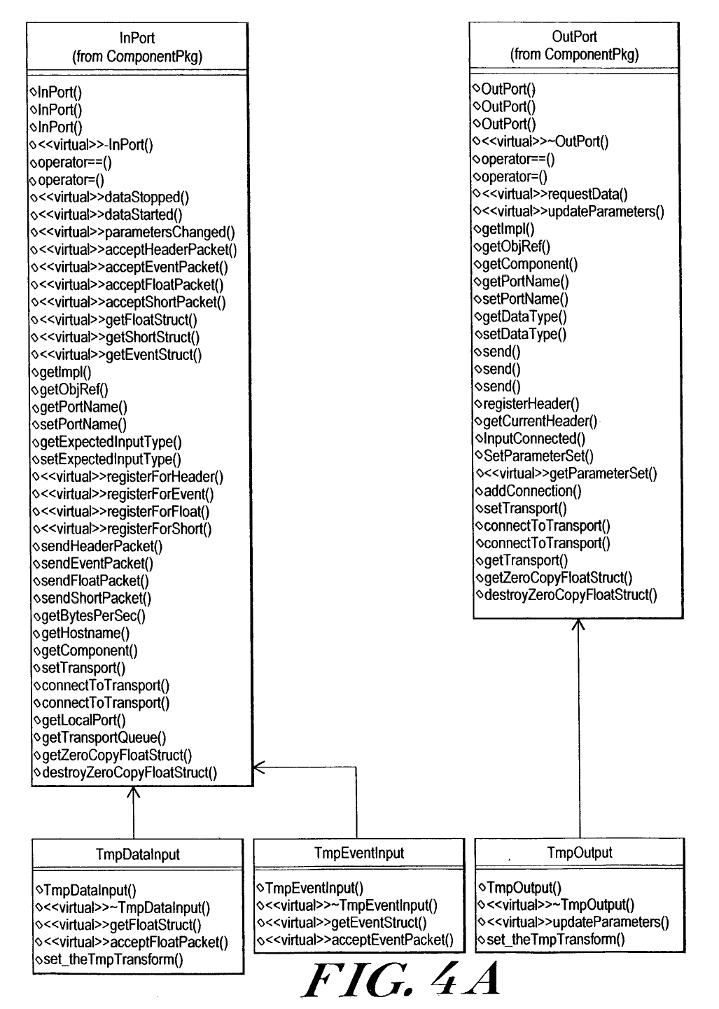

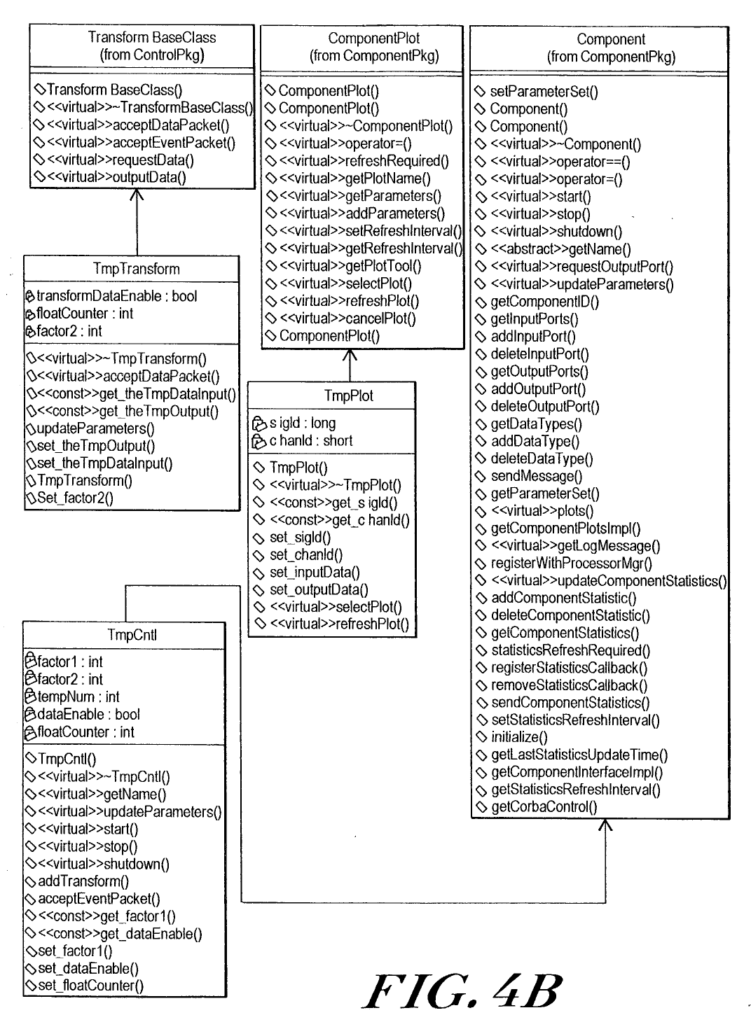

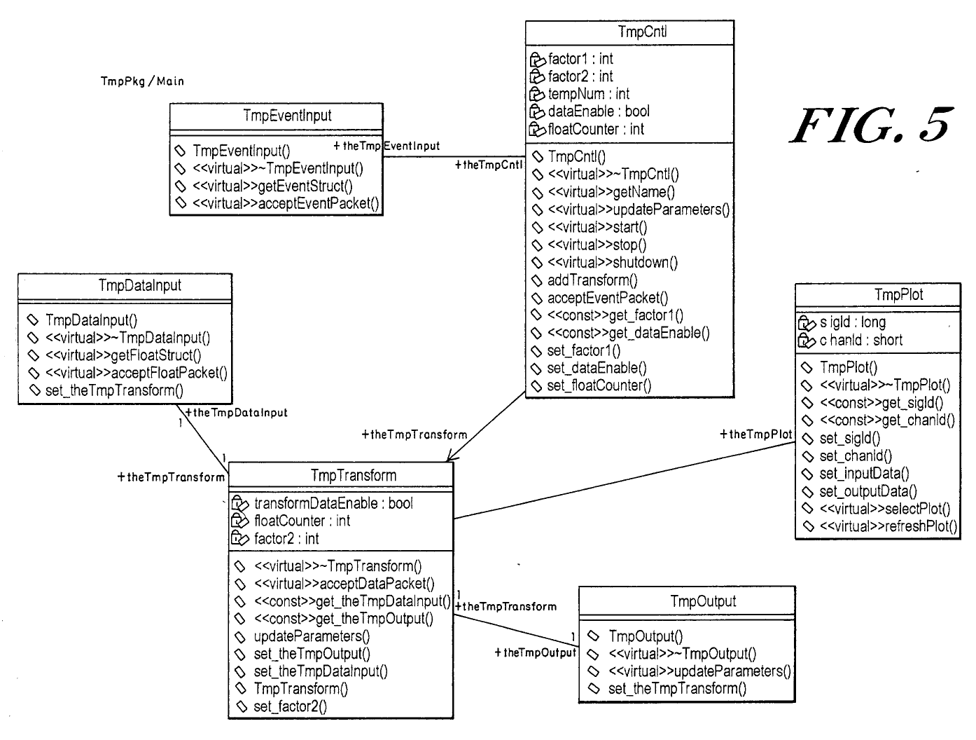

Each component developed to be interoperable, is developed by extending the base classes for the input port, output port, component, transform, and plots, and using the parameters class. Referring to FIG. 4, a simple example component, the TMP component is presented. Each of the base classes are extended for the particular specialized additional capability required for the particular component.

Note: for purposes of illustration, and as one example of a practical embodiment of the subject invention, the C++ language representation for methods is used. Other embodiments of this invention may use other object-oriented programming languages, such as JAVA. The specific method names identified herein are only as an example of one embodiment of this invention.

With respect to the input port, the base class for the input port is the inPort class. InPort is used by the component writer and is extended for the particular component. In the case of the TMP component, the tmpDataInput and TmpEventInput classes each extend the inPort base class. The purpose of the input port is to accept signal data or events into the component. The inPort class has a number of methods that the component writer uses and extends. Signal data or events are decomposed into packets for transmittal across the data communication fabric between output ports and input ports. The input port accepts three types of data packets that are essential for signal processing. These consist of headers and a payload. The headers provide auxiliary descriptive data, so-called side-channel data representing where, when and how the data was collected, and possibly processed. The first two types of data, shorts and floats are two types of signal data where the values in this data represent sampled signal data. Real or complex data may be passed. The third type of data is data which represents events, typically processing results which are representative of single action activities in time, which serve as triggers for subsequent signal processing.

### Component Inputs

The inPort base class has methods for initialization and shutdown. The constructor InPort( ) and destructor ˜InPort( ) are extended by the component developer to become the particular inPort that is used for the particular component. In the example, these extended or specialized methods are TmpDataInput( ) and ˜TmpDataInput( ), for the TmpDataInput class, and TmpEventInput( ) and ˜TmpEventInput( ) for the TmpEventInput class. The constructor is used to create all the required data structures for a particular object of class inPort. Likewise the destructor is used to delete them. Methods are provided for message registration permitting the component to identify if it wants to receive incoming signal or event packets, which are registerForHeader( ) and registerForEvent( ), registerForFloat( ), and registerForShort( ). Until there is registration, no data is passed. The methods for registration for messaging are generally not overwritten, but the base class method is used directly, as in the example. These methods generally provide all the essential functionality needed by the port. Methods are also provided for message buffer management: getFloatStruct( ), getEventStruct( ), getZeroCopyFloatStruct( ) and destroyZeroCopyFloatStruct( ), which allow the extended component to specially manage memory for incoming packets. Typically, the methods for message buffer management are used directly as inherited from the base class. However, these may be overloaded by the component writer for special customized buffer management. There are methods for the receipt of messages: acceptHeaderPacket( ), acceptFloatPacket( ), acceptShortPacket( ), acceptEventPacket( ). These methods must be overloaded by the component, and generally are the entry point for the signal processing algorithm software. These methods are invoked by the input port upon receipt of the packet message at the framework interface of the input port, providing of course the appropriate registration method has previously been invoked. These methods execute signal processing, typically by making and method invocation of a method in some object, often the transform object, that will actually perform the signal processing. In the example, the acceptFloatPacket( ) methods of TmpDataInput invokes the acceptDataPacket( ) method of the object of class TmpTransform. In the example, the acceptEventPacket( ) method invokes the acceptEventPacket( ) method of the controller, the TmpCntl class, to set the attribute data enable of the controller. For additional utility there are miscellaneous methods used by a component developer and the Framework Manager. These include setPortName( ) getPortName( ), which allows the components to set and retrieve an identification character string for the input port. The method getExpectedInputType( ) allows an application to query the inPort to see what type of data is it expecting to receive. Likewise the method, setExpectedInputType( ) establishes that. The method getBytesPerSecond( ) allows objects within the component to obtain the amount of data passing through the input port. These miscellaneous methods are generally not overloaded by the components developer as they provide all the required functionality directly from the base classes.

The above methods are common to all the signal processing and are used by the component input port to launch the signal-processing within the component. It will be appreciated that the few data types accepted and processed by the inPort base class accommodates all of the input signals that one would expect to receive in a signal processing system; they are reused no matter what type of specialized signal processing is provided by the transform within the component.

The input port also interfaces with the framework to actually receive the communication of data or events from the output port of some other component. This framework side of the interface has, an acceptFloatPacket( ), acceptShortPacket( ), and acceptEventPacket( ) method. In one embodiment, these exterior methods are implemented as methods of interface classes in IDL, the interface definition language for CORBA.

Additionally, this framework side interface has a method called addConnection( ) point which allows for connection-based communication mechanisms that establish a virtual connection from output port to input port along with an associated protocol handshake, as part of the communication link establishment sequence, when required by the communications mechanism.

### Component Control

With respect to the component base class, the purpose of the component base class and the component, which is extended from the component base class, is to control the operation of the component itself. In the present example, the class TmpCntl extends the base class Component. Generally, this class is a singleton object, that is only one per component. The functionality of the extended component includes the initialization of the component, the setting up of the input ports, the output ports, the parameters and connection to the Processor Manager. The extended component class initializes the number of input and output ports needed and provides the start, stop, and shutdown mechanisms for the component.

A number of methods must be defined in the class extended from the component base class. These include the constructor and destructor, in this example TmpCntl( ) and ˜TmpCntl( ). The component base class has methods to manage any data input/output activity. The start( ) method of the Component base class is overloaded in start( ) of the TmpCntl class. This method is invoked when the component may emit data and initiate signal processing. Similarly, stop( ) is the method that is invoked by the framework to indicate the component is to stop emitting data. The requestOutputPort( ) method performs any necessary processing when the framework requests the creation of an additional output port. The component may either extend this, in that cases adding the functionality or creating the new output port, or as in the example TmpCntl, may not overload this method if the component writer desires not to support this functionality in the component. The shutdown( ) method must be overloaded to clean up or stop any threads from being started and to remove any data structures created by new( ) or other similar memory allocation mechanism.

The method for getName( ) must be overloaded by the particular component, as is done in the example TmpCntl. This method returns a unique identifying string for the component. The methods to update the components statistics called update component statistics is also overloaded and methods to update components called parameters is called update parameters.

In the component base class there are non-virtual methods that are used un-extended from the component base class, as they provide to all the necessary functionality. These methods of the component base class include initialize( ), which is used to indicate any initialization is complete. The method getComponentID allows objects within the component access to the unique identifier for the instance of the component. A method sendMessage( ) is provided that is independent of operating system, compute platform, or available input/output devices to indicate error conditions. This method sendMessage( ) is used to send error messages to the Processor Manager, the Framework Manager and all who have registered to receive these error messages. Methods are provided to manage the input ports and output ports typically part of a component, and have associations with the extended component class. getInputPorts( ), getOutputPorts( ) return lists of the current input ports and output ports of that particular component. The methods addInputPort( ), addOutputPort( ), deleteInputPort( ) and deleteOutputPort( ) modify these lists of current input and output ports for the component. The component base class has a method getParameterSet( ) which allows objects in the component to have access to the parameter set class that controls component behavior. See below for a detailed explanation of the parameter set object.

Components have statistics allowing visibility at run-time to the processing operation of the component. Statistics are actually parameter sets that are output only, that is they do not permit changes to values external to the component. They provide a convenient mechanism for the component to present internal data to outside a component due to their self describing mechanism. Statistics are maintained within the component and may be queried and may be emitted periodically. The component base class provides methods to manage the statistics. The statistics typically represent information about the processing rate or effectiveness, such as samples processed per unit time, number of new signals detected, or other information germane to development and operation of signal processing systems. These methods include getComponentStatistics( ) providing access to the parameterSet object which is serving as the statistics object. During initialization, objects within the component may invoke the method addComponentStatistic( ) for each desired statistic, likewise during destruction the component invokes deleteComponentStatistic( ). The method sendComponentStatistics( ) sends the statistics to all objects that have registered. The component extends the component base class method updateComponentStatistics( ) to compute any new statistics values. Typically this is invoked just prior to sendComponentStatistics( ). A set of utility methods to manage the update timing of statistics is provided. The methods setStatisticsRefreshInterval( ) and getStatisticsRefreshInterval( ) establish and query the time between updates. The method statisticsRefreshRequired( ) is provided that the component invokes to test if the statistics refresh interval has a gain expired. In typical operation, if this method returns true, the updateComponentStatistics( ) and sendComponentStatistics( ) methods are invoked. Additionally, a convenience method, getLastStatisticsUpdateTime( ) is provided that permits objects within the component to ascertain when the last statistics update was performed. These methods offer a multiplicity of options for the component developer to manage statistics generation and reporting.

The component base class has as an attribute, a ComponentPlotSet object, which is a list of ComponentPlot objects. These plot classes will be described below. The component base class has an access method to the cormponentPlotSet, plots( ).

The component interfaces with the framework to receive method invocations to control the component, and to produce information requested of the component by the framework or outside applications. In one embodiment, these exterior methods are implemented as methods of interface classes in IDL, the interface definition language for CORBA. These exterior interfaces for the component include getting component attributes: getComponentID( ), getComponentName( ), and getHostName( ). The framework side interface to the component has the following methods: start( ) which starts the component operation, eventually invoking start( ) on the component, in the present example on TmpCntl; stop( ) which the framework uses to command the component to stop its operation, eventually invoking stop( ) on the component, in the present example, TmpCntl; shutdown( ) which the framework uses to command the component to prepare for shutdown and delete threads and to delete data structures, eventually invoking shutdown( ) on the component, in the present example on TmpCntl. Message logging is managed by enableMessageLogging( ) and disableMessageLogging( ) which are used to directly connect the sendMessage( ) from within the component to the frameworkManager and any other applications that have registered for error reporting. Graphical plotting applications outside of the component may invoke the getPlots( ) method, returning a list of plots the component has created and registered.

This framework interface to the component has access methods to the input and output ports. These access methods getInputPort( ) and getOutputPort( ) return the port, if one exists, given a name string of characters. Lists of input ports and output ports are available using the getInputPorts( ) and getOutputPorts( ) methods.

The parameters that control the behavior of the component are available to the framework and outside applications via the getParameter( ) method, and are settable via the setParameter( ) method. The definitions of the parameters are available via the getParameterDefs( ) method.

The statistics available within the component are available represented as parameters via getCurrentStatistics( ) and the definitions are available via the getStatisticsDefinitions( ) methods. A callback is established to request periodic statistics updated by the component by invoking establishStatisticsCallback( ), and may be canceled by invoking cancelStatisticsCallback( ).

The requestOutputPort( ) method allows the framework to request the component to create a new output port on demand, and calls the requestOutputPort( ) method of the component, if overloaded. The releaseOutputPort( ) method likewise will request the destruction of any newly created output port that was created this way.

### Component Outputs

With respect to the output port interface, the OutPort base class provides two required functions inside the component. First, is the emission of the signal or event data that was just processed by the component. Again, this is in the form of float data or short data with a header or event data, for instance, when the signal-processing component is providing such detection and the detection actually occurs from the signal data that is fed into it. The second functionality of the output port is to manage parameters that are used to control the transform associated with the output port. In the example, the TmpOutput class inherits from the OutPort class. The parameters of this output port control the behavior of the TmpTransform class, which is associated with the TmpOutput class. The constructor OutPort( ) and destructor ˜OutPort( ) are extended by the component developer to become the particular inPort that is used for the particular component, In the example these extended methods are TmpOutput( ) and ˜TmpOutput( ). The OutPort base class has other methods that typically are used without extension, including getComponent( ) which allows the application to get the reference of the component that contains the outport, and getPortName( ) and setPortName( ), a string used to identify the outport to the Framework Manager. The send( ) method is the method invoked by the component or transform within the component to actually send the data from the output port of one component to the input port of another component.

There are methods to manage the output port parameters. These parameter controls the behavior of the transform associated with the outPort class. This includes the method updateParameters( ), which is a method of the extended outPort class, such as TmpOutput in the present example. This method is invoked when parameter values are changed, and contains the specific behavior programmed by the component developer to occur upon changes in parameters of the OutPort. The methods of the base class getParameterSet( ), and setParameterSet( ), are used by the component or transform to define the set of parameters typically during construction of the OutPort object, and to get the current parameter set object.

The output port also has an interface to the framework to actually communicate data or events to other components, and to manage this communication, plus for the management and control of parameters of the transforms associated with the output ports. In one embodiment, these exterior methods are implemented as methods of interface classes in IDL, the interface definition language for CORBA. The interface includes methods to get the port name get_portName( ), get the emitted data type, get_dataType( ), and get the list of inputPorts connected to the output port, getinputConnections. The parameters of the output port are obtained from outside the component using the getParameters( ) method. The definitions of the parameters of the output port are obtained from outside the component using the getParameterDefs( ) method. Outside applications or the Framework Manager change values of these parameters using the setParameters( ) method. The method connectInput( ) is the mechanism the Framework Manager uses to establish the connections from the output port to the input port of the other component. The disconnectInput( ) method removes the connection established by the connectInput( ) method.

### Parameters

The parameters are now described. Parameters are self describing entities that control the behavior a component or of a transform associated with an output port. Parameters are consistent over the life of the component that is, they exist in the beginning of the component until the component destructor is called. Parameters always have the default values, and the values of parameters can be modified after they are set. Again, parameters are externally observable, that is, observable by the Framework Manager and outside applications, as well as being observable internally to the component.

The parameters are managed by the ParametersSet class, which is a container class, which can store individual parameters as parameter records. The ParameterRed objects are, stored in the parameterSet. Each ParameterRed describes the single parameter that controls the signal processing behavior of the transform or of the component. This behavior is controlled at runtime. By using this parameter interface, there is a common mechanism for all components in order to modify the behavior of the component regardless of the detailed parameters. The ParameterSet class is not extended but is used unchanged. It is used in its entirety to provide all its capabilities simply by changing the values at runtime. Each individual ParameterRed object can store one of three types of data, integer, double or a string. Each ParameterRed object has the following five entities: the current value, the default value that exists when the component is first constructed, the minimum acceptable value, the maximum acceptable value, and a list of acceptable, values where acceptable values can be enumerated, instead of being controlled by a minimum and maximum. If an attempt is made to set the value of a parameter outside of these minimum and maximum limits, an exception automatically occurs and the value is not set within the component.

The following methods are provided to control objects of class ParameterSet, which is the container of multiple parameter records. These methods include methods used for accessing the parameters, getIntParameter( ), getStringParameter( ), getDoubleParameter( ), getName( ). The method getIntParameter( ) obtains the value element of a ParameterRed of a specified name in integer format. The method getStringParameter( ) obtains the value element of a ParameterRed of a specified name in string format. The method getDoubleParameter( ) obtains the value element of a ParameterRed of a specified name in double precision floating point format. The method getName( ) returns the name of the ParameterSet established typically by the constructor of the component. There are complementary methods to set the parameters: setName( ) establishes the name of the parameterSet, setParameter( ) establishes the value of the ParameterRed identified by the name specified. A convenience method is provided for the component or other objects within the component, to fetch parameters modified by the framework or other outside application, fetchModifiedValue( ) and fetchNextModifiedValue( ).

There are methods provided on the ParameterSet used to add, update and delete parameters. These are typically used during the construction or destruction of the component. The addParameter( ) method accepts new parameters by name and default value, and is used by components to create unique parameters for a particular signal processing application. The method addEnumeration( ) accepts enumerated values such as “A”, “B”, “C”, or “D” to be added to a specified parameter. The method removeParameter( ) allows for the parameter to be removed. This is typically used during the destructor. There are methods used to reset parameters to default values, resetAll( ) and reset( ) which take the name of the parameter. This allows the component to return to the default value rather than a currently set value, a value that was set by the Framework Manager. The updateParameterSet( ) method tests each value of each parameter to ensure it is within bounds prior to setting the value of the parameter.

Each ParameterSet is composed of ParameterRed objects. A ParameterRed class has a number of methods that are used to manipulate the parameter record itself. The constructor for the ParameterRed object creates the object. The method getDataType( ) retrieves the data type of a particular ParameterRed object. Additional methods on the ParameterRed class include getAcceptableValues( ) which returns a vector of acceptable values set during the construction and creation of the ParameterRed. The getName( ) methods returns the name of the parameter, getDoubleParameter( ) returns the value of the parameter as a double precision floating point number, getStringParameter( ) returns the value of the parameter as a character string, and getIntParameter( ) returns the value of the parameter as an integer. The method getDefaultValue( ) returns the default value of the particular parameter record. The method SetParameters( ) attempts to set the value of the parameter, first checking the minimum and maximum acceptable values, or the permitted enumerated values. The methods getMaxValue( ) and getMinValue( ), returns the maximum and minimum acceptable values of the parameter, which was set when the ParameterRed was constructed. The method getValue( ) gets the actual and current value of that ParameterRed.

The component interfaces with the framework to set and get the parameters of components or output ports. In one embodiment, these exterior methods are implemented as methods of interface classes in IDL, the interface definition language for CORBA. These exterior interfaces for the parameters interface to the framework is through the component base class. The parameters that control the behavior of the component are available to the framework and outside applications via the getParameter( ) method, and are settable via the setParameter( ) method. The definitions of the parameters are available via the getParameterDefs( ) method. Upon a setParameter( ) invocation, the parameter is checked and the updateParameters( ) method of the extended component base class is invoked. In the present example that method is the updateParameters( ) method of TmpCntl. The component updates any attributes and performs any changes in behavior as the parameters dictate.

Transform

What is now described is the transform base class. The transform base class is extended by the component developer. The transform is one instance of the signal processing performed by the component. The transform class is where the signal processing work gets done inside the component. In the present example, each object that will perform the signal processing is of class TmpTransform, which inherits from TransformBaseClass. This encapsulates the signal processing involved inside the component. At least one of the transform base class methods acceptDataPacket( ) and acceptEventPacket( ), must be overloaded by the component developer, as is done in the present example TmpTransform class, having the acceptDataPacket( ) method which is where the signal processing code goes. When data arrives at the component, it arrives in the input port, on the framework side of the interface, invoking acceptFloatPacket( ), for example if the data type is floating point data representing signal samples. The component extended inport, in the example TmpDataInput, calls the acceptFloatPacket( ) method. This method typically calls the acceptDataPacket( ) of the extended transform object, in the example TmpTransform. The acceptDataPacket( ) of the extended transform object performs the signal processing work. When the signal processing work is completed for that packet, the transform object invokes the send( ) method on the output port. The transform base class has minimal functionality, but is extended and is where the signal processing work is inserted by the component developer. All the other required interfaces and infrastructure support are provided by the extended inPort class which, again, is providing input data in proper format as it arrives.

### Plots

With respect to the Component plot interface, it should be first mentioned that traditional software development tools do not provide useful representation of vectors or arrays of sampled data such that a signal processing engineer can quickly visualize the internal functioning, or perhaps more correctly, the malfunctioning of the component software during development. The plot class is an interface is to permit the visualization of the data in a graphical format. Specifically for signal processing, this is the software analog of an oscilloscope probe.

The plot capability includes the ComponentsPlot set class and a ComponentPlot. The ComponentPlotSet is a container class of ComponentsPlots which will be described first. The Component base class has one ComponentPlotSet. The ComponentPlot provides updated graphical plot of data within the component used for signal processing debugging and diagnostics. These plots can be viewed with an external application. The ComponentPlot class is extended to create a plot class specifically for that component. In the example it is class TmpPlot. Each extended ComponentPlot has a parameter set to define and control the behavior of the plot itself. This interface is similar to the parameter set of the component, and in fact, uses the same class parameterSet. The extended ComponentPlot has a method for getting the plot name: getPlotName( ). The extended ComponentPlot class also has methods to manage the plots updates: selectPlot( ) which is called when the external plotting application requests the plot, and refreshPlot( ) which is called internally by the component and provides the rendering of the plot. The selectPlot( ) and refreshPlot( ) methods are completed by the component developer to render and populate the plot using plot tool interface methods, which will be described later. The ComponentPlot base class has a method to obtain the parameters of the plot: getParameters( ), and a method to obtain the plot tool interface that is the reference of the external application via getPlotTool. The ComponentPlot base class method refreshRequired( ) which tests whether a timer has expired and whether, it is time to render the plot and the method setRefreshInterval( ) which establishes how often the plot should be plotted.

The ComponentPlotSet class is the container of ComponentPlot objects. The methods on the ComponentPlotSet provide access methods by name: getPlot( ), getParameters( ), refreshRequired( ), refreshPlot( ) and selectPlot( ) and cancelPlot( ) for an entire container of plots. These are similar in functionality to the similarly named methods on the individual ComponentPlot class. The ComponentPlotSet class also has methods for adding a ComponentPlot object once created: AddCPlot( ), and for removing a ComponentPlot object: RemoveCPlot( ).

The component plot interface also interfaces to an external graphics plotting application for the framework. This interface is typically used by the selectPlot( ) and refreshPlot( ) methods on the extended ComponentPlot object, in the present example, an object of class TmpPlot, to render plots on the external graphics plotting application upon request of the external application. From within the component, this interface is constant. This interface has a method to add and initializes a plot and a method to remove a plot: addPlot( ) and removePlot( ). A method setPlotTool( ) is provided to specify which instance of an external graphical plotting application is to be used, given a handle, the format of which is a function of the underlying communications mechanism used in the embodiment of the framework. A method is provided to add and initialize a text panel on the external plotting application, addTextPanel( ), to clear text from the rendered panel, clearText( ), and a method to write text to the panel, writeText( ). Methods are provided to plot a vector of signal data as a function of index, plotfx( ), and to plot a pair of vectors of signal data, one vector being the abscissa, and one being the ordinate of the point to be rendered, plotxy( ). As described, the external graphics plotting application interfaces with components to receive commands to render plot information graphically. In the preferred embodiment, these commands are implemented as methods of interface classes in IDL. These methods have the same nomenclature and arguments as the methods just described.

The component interfaces with the framework to manage the plotting functionality. In one embodiment, these exterior methods are implemented as methods of interface classes in IDL. These exterior interfaces for the plots interface to the framework is through the component base class. The plot interface on the exterior of the component consists of a method which an external graphics plotting application can invoke to query each component for all the possible plots that it can provide, getAvailablePlots( ). An external graphics plotting application can also query the component for the parameters that may control the plots, parametersForPlot( ). When an external graphics plotting application needs to commence rendering the plot, it invokes the selectPlot( ) method on the exterior interface, which invokes the selectPlot( ) and refreshPlot( ) methods on the extended ComponentPlot object, in the example, an object of class TmpPlot. These methods use the rendering methods described above, such as plotfx( ), to render plots on the external graphics plotting application. When an external graphics plotting application no longer requires the rendering of signal data, it may invoke the cancelPlot( ) method which indicates to stop rendering the particular plot.

### Framework Manager

Having described the base classes and their application to an example component, attention is now turned to the Framework Manager.

It will be appreciated that the entire functionality of the Framework Manager is captured by the interface, which will be described.

The Framework Manager is the root object for the system. It is a singleton in that there is one and only one in each system using this component and framework architecture. The responsibility of the Framework Manager is to keep track of all processors and components. It allows an outside application or applications to identify and locate the processors and components executing on those processors. The Framework Manager's principal role is to manage and deploy the Plan, the Plan being the location of the components on the computers, component interconnection, and the parameters that control component behavior. These three things, in combination, define the system itself including its operation and its ultimate function as a signal processor.

Framework Manager has a method for the Processor Manager to register, registerProcessor( ), used when the each Processor Manager starts operating, used to indicate to the Framework Manager that processor is available for use in the system. A method is provided for any outside application program to get the list of Processor Managers currently registered, getProcessors( ). The Framework Manager has a methods to obtain a list of which, components are currently executing on each processor, getProcessorDetails( ). A similar method is available that identifies the processor executing a particular instance of a component, getProcessorForComponent( ).

A number of methods of the Framework Manager provide control and status information relative to the component itself: a method to register a component which a Processors Manager invokes when the component has been loaded and is ready to run, registerComponent( ); and similarly unregisterComponent( ) which is called by the Processor Manager when the component has shut down; and a method to get the list of components matching certain text strings called getComponents( ). Likewise, a similar method findComponent( ) returns a list of components matching certain names and parameter name value pairs.

There are a number of methods the Framework Manager provides that are used for the deployment of components. They are used by an outside application in preparation of a Plan. The first is allocateComponenID( ) which ensures, a unique component identity on the existing system. The enterPlan( ) method accepts a Plan as a formatted data structure to be entered and deployed, and connections established and parameters set on the particular components identified in the Plan. A similar method enterPlanAsText( ) is also available that accepts the Plan in a human understandable text format. Similarly, enter PlanAsFile( ) allows a file name to be specified and the Plan read from the specified file. Once entered into the Framework Manager, the Plan may be started. A method called startPlan( ) starts all the components in a Plan with the specified name. A method stopPlan( ) stops all the components in a Plan with the specified name. The method removePlan( ) shuts down, invokes the shutdowns method on each component, and unloads all the components, given the specified Plan name. The method listPlan( ) provides a list of all Plans that have been deployed or entered into the Framework Manager. The placeComponentMethod( ), which allows an individual component to be placed in addition to that of the Plan. The removeComponentMethod( ) which removes an individual component. The makeConnection( ) method which connects between the output port of one component and the input port of another component. This can be done individually in addition to those identified in a Plan. Likewise, removeConnection( ) method removes an individual connection.

It will be appreciated that each of these methods will be used to provide various configuration and reconfiguration at runtime of the system. In addition, the Framework Manager has an extensible interface to a configuration manager object, not included in this system, which allows an external algorithm to be used for automated deployment, and connections of components, in some optimized manner.

In summary, the Framework Manager allows one to configure and reconfigure the entire signal processing system to be able to add and subtract functionality and reconfigure the entire system on the fly, thus to be able to provide differing signal processing functions within the same equipment suite.

In the configuration process the Plan is read by the Framework Manager in one of its many forms as described above. The components are activated on each of the processors specified each of the components are constructed and are then connected with their initial parameter setting are set. When all that is completed, then each of the components have their start( ) method invoked, which then starts the processing and emitting of data out of the component.

To reconfigure, in the simplest example, a pair of components is disconnected by the Framework Manager, the first component is shut down, another third component deployed, and this third component is connected by connecting the output port of this third component to the input port of the second component. The third component is started and the system now operates performing a different functionality on the same equipment.

### Processor Manager

As another integral component to the signal processing system as described above, what is now described is the Processor Manager.

The Processor Manager program resides on each processor within the system. The Processor Manager program is automatically started on each processor when the processor boots up. The Processor Manager is an extension of the Framework Manager projected onto each processor. The Processor Manager loads and starts components at the direction of the Framework Manager, and reports the current processor status and utilization to the Framework Manager. The Processor Manager methods include the method ping( ), which by invoking, the Framework Manager can determined whether the Processor Manager is currently operating; and the registerComponent( ) method in which a component executing on the processor invokes upon its construction to inform the Processor Manager that the component is ready to process. The enableMessageLogging( ) and the disableMessageLogging( ) methods are used by the Framework Manager to tell the Processor Manager to forward any error messages created in the components using the Component base class method sendMessage( ) from the component to the Processor Manager, to the Framework Manager, and which then may be passed to an external application to display the error messages. The listLoadedComponents( ) method provides a list of components currently loaded on the processor. The loadComponent( ) method is used by the Framework Manager to request a particular component be loaded on the processor managed by the Processor Manager. This is typically used during the initial deployment and configuration by the Framework Manager. The removeComponent( ) method is used by the Framework Manager to shutdown and unload the component from the processor managed by the Processor Manager. In addition, the Processor Manager provides usage metrics, which may be used for optimization or analysis of component deployment: the fetchMetrics method which returns data about the processor utilization and memory utilization.

While the subject system has been described in terms of components, base classes, a Framework Manager, and a Processor Manager, when it runs a particular signal processing task, it may involve the communication with outside application programs. Note that the outside application programs can also be used for diagnosing the system. Outside application programs are illustrated at 50 in FIG. 2 which function as follows:

The outside application program interfaces to the parameter set, parameter record and the interface of the components changing individual parameters, which change the behavior of the components at runtime. Additionally, the outside application program can contain a plotting application used by the component plot class. This is referred to as the plot object.

The outside application can also change parameters of the components. The outside application can graphically render the plot output as provided by the components and the component plots interface 40. By changing the parameters on the component or the parameters of the output port, the behavior of the transform and component can be changed at runtime and the effect of those changes can be observed on those component plots which are returned to the outside application program.

### Layered Architecture

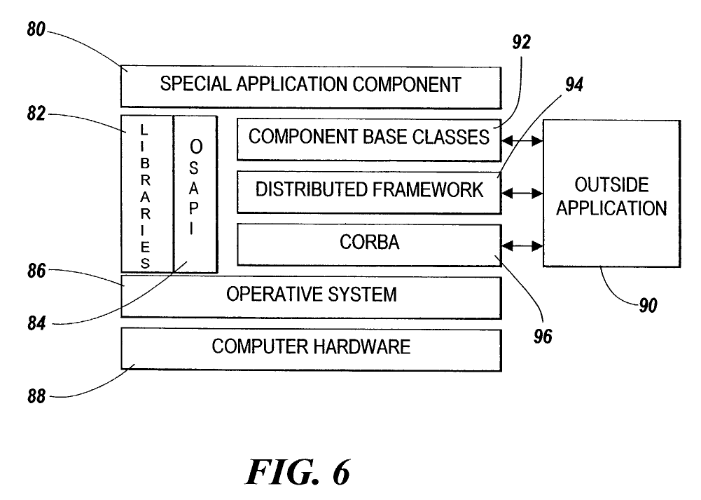

Referring now to FIG. 6, the layered architecture for the present invention is shown. By a layered architecture is meant that objects or modules of the system software are organized into sets referred to as layers. When a module is part of one layer it can use any other module in that layer directly. However, when a module in one layer must use the capabilities in another layer it can only do so according to the strict interface definition at the layer-to-layer boundary. Layers are used to reduce complexity by restricting relationships between modules thereby providing independence between different parts of the system. The goal is to increase reusability and maintainability in software systems. For example, by layering the operating system interface, one ensures that a change in operating system does not affect the entire software system.

As illustrated in FIG. 6, particular computer hardware 88 actually executes the computer code to run the signal processing application. Higher level software does not interact directly with the computer hardware, instead it interfaces through the specific Operating System 86. Example operating systems which have been used for implementing this system include Microsoft Windows NT, VxWorks, and LINUX. Since these various operating systems and others all have somewhat different interfaces, the translation is isolated within the Operating System Application-Programming Interface, or OSAPI, layer 84 composed of the OSAPI class.

The OSAPI provides platform-independent and operating-system-independent methods to access the underlying operating system capabilities. Thus the OSAPI layer is a translation from the native operating system to a common interface used by the components regardless of the native operating system or native hardware platform.

These include but are not limited to methods to change specific directory or path, chdir( ) or fixPath( ); methods to start a task 6 or perform a system call, spawn( ) and system( ); methods for environment initialization or host management, startup( ), getHostName( ), hostType( ); and methods for swapping bytes and determining the so-called Endian type of the platform, such as littleEndian( ), swap2 ByteData( ), swap4 ByteData( ), swap8 ByteData( ) which provide platform independent operation. Methods to handle time functions using seconds or microseconds such as getHighResTime( ), geTimeofDay( ), timeToText( ), sleep( ), usleep( ) may be used; and other methods to control processing include, taskLock( ), taskUnlock( ), contextSwitch( ) and to move data, fastestCopy( ). These are all independent of the underlying actual operating system and allow the same source code to be used in multiple processor environments and operating system environments. Endian describes the ordering used natively by the machine in a multi-byte word. For example, a four byte integer in little endian representation has the least significant byte placed first in memory and the most significant byte placed fourth in memory. In big endian representation, the first byte in memory is the most significant byte; the third byte or the fourth byte in memory is the least significant byte. This endian conversion, byte swapping and endian test permits interoperation between different types of computer hardware.

A Libraries layer 82 provides a standard set of calls for signal processing primitives such as Fast Fourier Transform FFT( ) and Finite Impulse Response Filter FIR( ). The interfaces to these libraries is constant regardless of the actual computer type being used to perform the computations. In one embodiment the interface to the components is provided by the industry-standard Vector Signal and Image Processing Library (VSIPL). Most hardware vendors provide VSIPL libraries that are optimized for their hardware platform.

The CORBA layer 96 provides default method for remote object method invocation in one embodiment. CORBA stands for the industry standard Common Object Request Broker Architecture and it is implemented by an off-the-shelf product. This selection is in keeping with the underlying object-oriented architecture of the system, but can be changed and so has been isolated in its own layer. Other communication means include sockets, which are supported by the target operating systems, and the native communications protocols of the switched fabric interconnects-are also available within the distributed framework.

A Distributed Framework layer 94 consists of the Framework Manager, Processor Managers and other objects and services which provide the infrastructure for operating the components in a system.

The Component Base Classes layer 92 provides most of the generic capabilities needed by all components in the system. These base classes are described in detail above. This layer facilitates rapid development of components from direct reuse of much common software code. By providing the interface between the Specific Application Components 80 and the interface from the Components 80 and the Distributed Framework 94, it relieves the software component developer from the burden of complying with these interfaces.

Specific interfaces are also defined between the Component Base Classes, the Distributed Framework, CORBA, and the Outside Applications 90 which control the system and receive the processing results. Examples include the plot interfaces, parameters interface, and statistics interface from the component base classes, and the Framework Manager and processor manager interfaces as described above.

### Observation Tool

Having described an operational distributed computing signal processing system, it now remains to describe an observation tool for observing the operation of the components of the system, especially during run time.

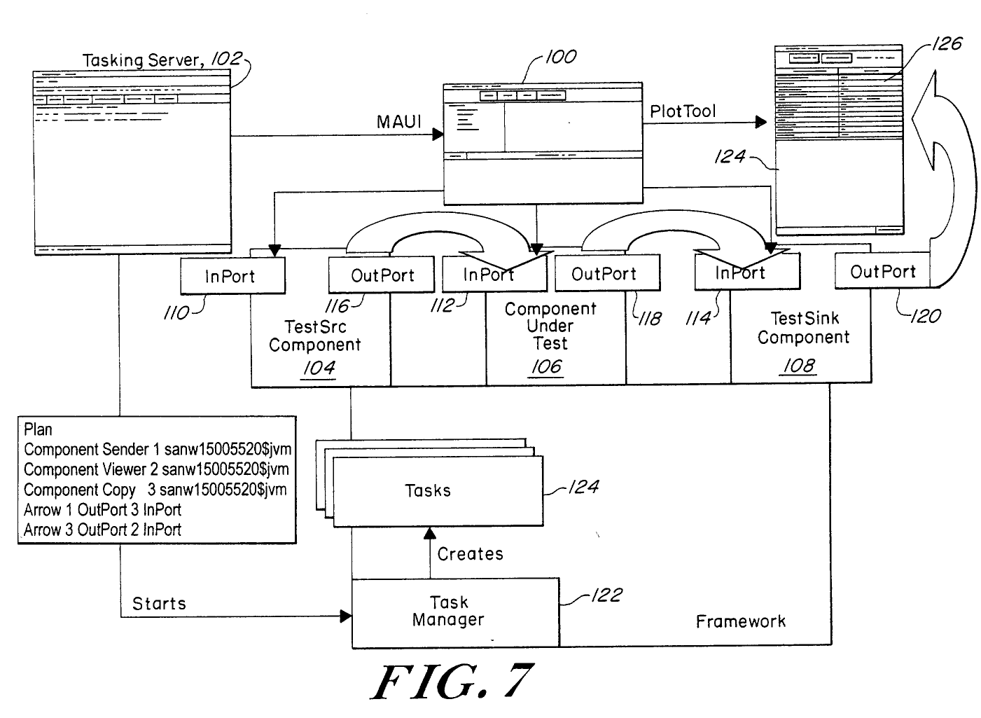

Referring now to FIG. 7, an observation tool in the form of a maintenance and user interface MAUI 1100 starts a task by calling a tasking server 102 to interrogate a number of components here illustrated as Test SRC component 104, Component Under, Test 106 and Test Sync Component 108 by accessing various input ports or inports respectively 110, 112 and 114, with respective outports 116, 118 and 120 providing as an outport the result of a particular processing function of each of the components to the next input port.

In so doing, tasking server 102 starts a Task Manager 122 which can create a number of tasks 124 for each of the components, with the operation of the Task Manager under the control of the aforementioned Framework Manager.

The result of the MAUI quering the various components is a plot, here illustrated at 124, superimposed below a window 126 that provides information about the component being queried.

It will be appreciated that each of tasks 24 executes a task in accordance with the aforementioned Plan so that for each component there is a system a Plan that defines its operation, its initialization and the output therefrom.

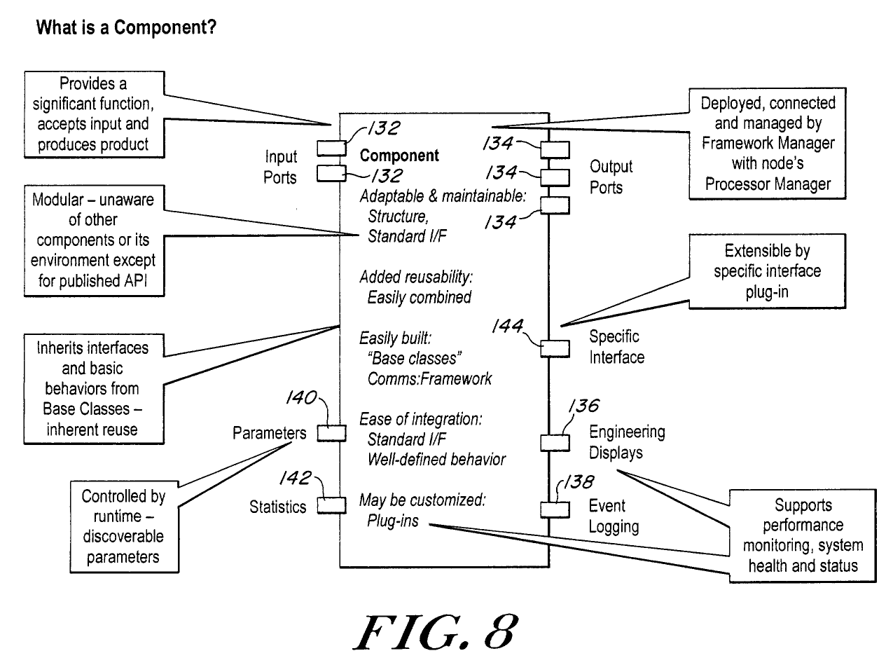

Referring to FIG. 8, an external view of a component 130 and all its interfaces is shown. Each of the shown input and output ports 132 and 131 may be compared to pins on an integrated circuit and actually in fact behave in a similar way, with the one additional capability that they can describe themselves. For example, the input port on a component has a property of the data it is expecting. Output ports describe what the output ports generate and also describe what connections they have. Engineering displays 136 are shown in the same way, as is event logging 138, parameters 140 an statistics 142. Also, there may be a dedicated specific interface 144.

Once the user accesses a particular component and it is actually instantiating the system, meaning that it is running on a processor, the user can take the MAUI observation tool and attach it to that component. Once the observation tool attaches itself, it goes to the input ports and queries the component regarding what all the input ports are, what all the parameters are, where all the statistics are, where all the output ports are, and where connections are. The tool then reconfigures itself on the basis of this information so as to allow the user to go through and select each one of these pieces of information and get more detail on it.

Accordingly, as the system is running with perhaps thousands of components the user can go into any one component, and virtually attach the subject observation tool to it and find out exactly how it is behaving and how it is performing.

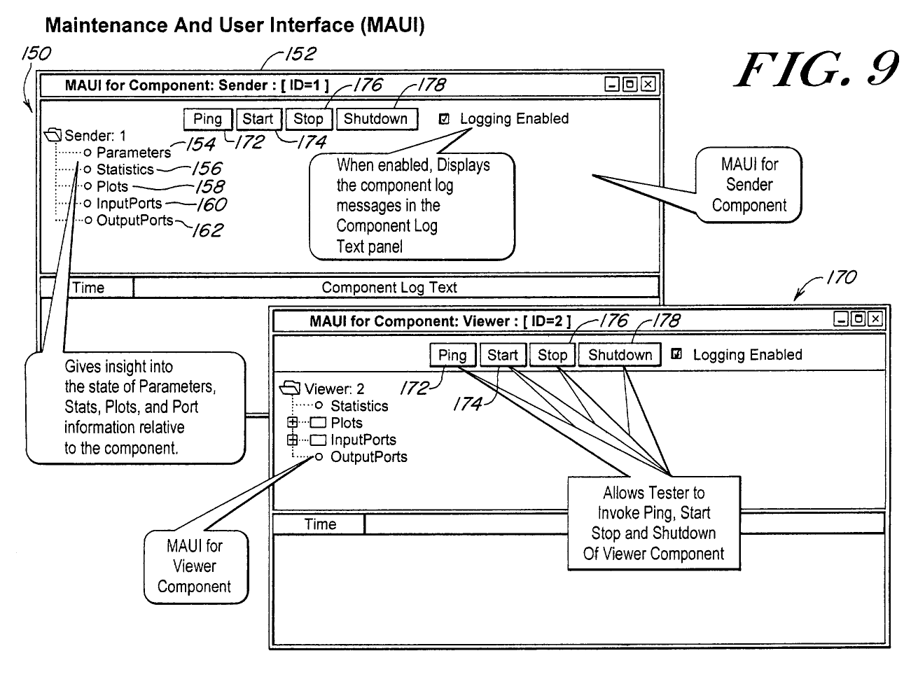

Referring to FIG. 9, a sender display 150 is shown. While this particular display is not yet well populated, it can be seen the component name 152 is in the upper left, and is called “Sender”. The component ID is number 1 and there are tags 154-162 for parameters, statistics, plots, input ports and output ports. For this particular example, output ports have a folder meaning one or more output ports in this component. The other display 170, called “View 2”. As far as plots are concerned, each of the plots have a folder. In other words there are several plots and there are several input ports. Accordingly, if the user goes through with his mouse and clicks any one of the icons with the little plus next to it, it will expand it out one level and the user can see what the different pieces of information are. Note that screens 150 and 170 each move a ping button 172, start and stop buttons 174 and 176, and a shut down button 178 to invoke the noted functions.

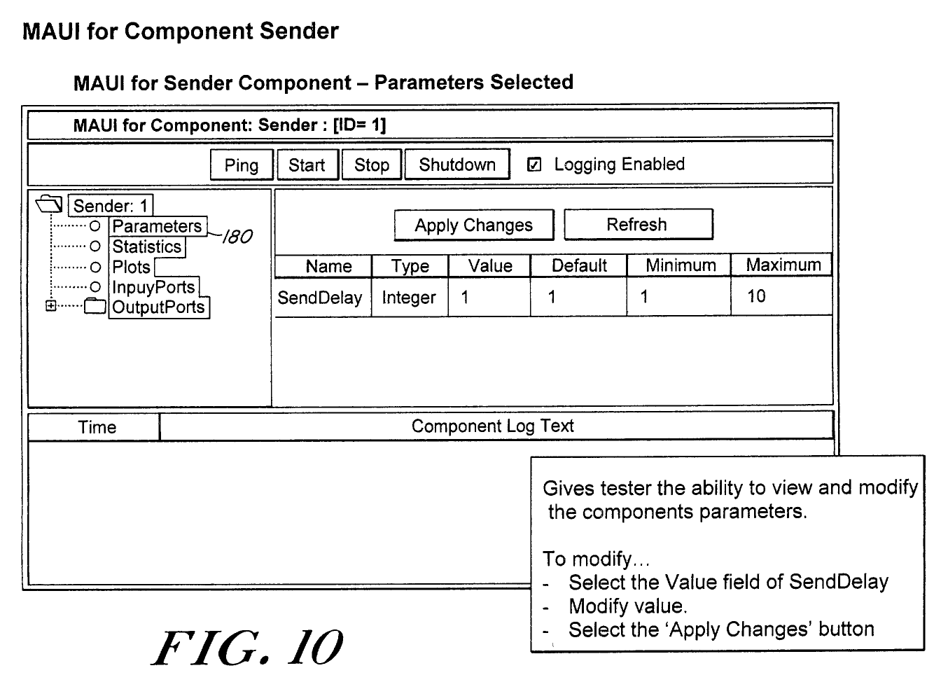

Referring to FIG. 10, as shown at 180 that the user can select the parameters item. In this particular component there is one parameter called “SendDelay”, which is an integer which has a current value of 1. Its default level is 1, and its legitimate range is 1-10. This shows how that parameter describes itself.

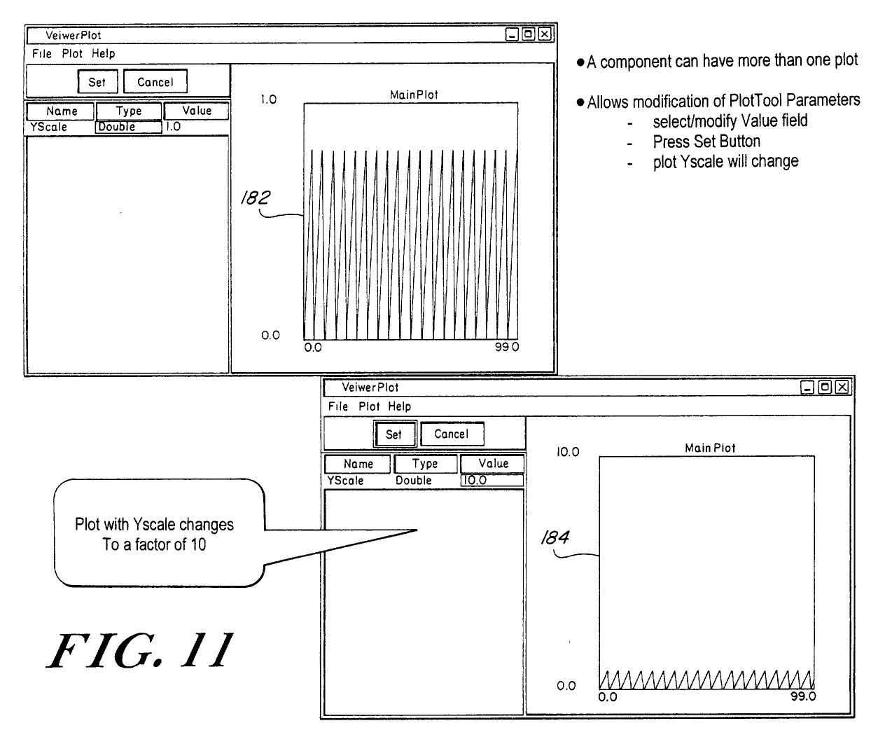

Referring to FIG. 11, various plots are shown at 182 and 184. Each component can optionally define engineering plots for itself such that when the user connects the MAUI to the component it gets a menu of what the different plots are. After the user selects the plot, it then pulls up another display which is a list of all the parameters applicable to that plot. The user changes those parameters, and once he enters the changed parameters the component draws a custom display for those components. In this way, if the user is developing a new algorithm and wants to look at some internal data, in writing the component he would create a particular engineering plot and this would be the mechanism by which he would access it.

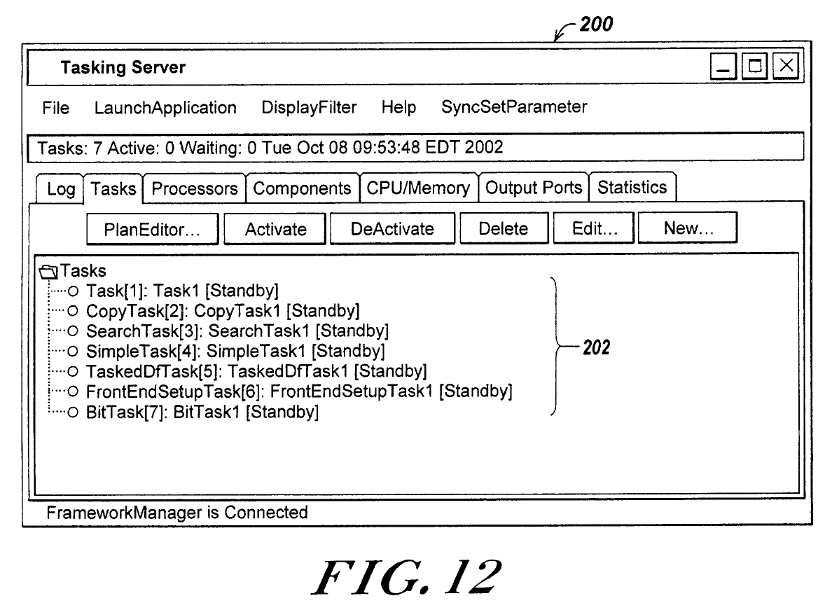

Referring to FIGS. 12-18 generally there is a description of system operation called a Plan. Note that for each screen the first word is a keyword. For example, there is one called “Component Framework Sender” and its number is 1. With this information the user can tell the Component Framework Sender where he wants it to run.

Note that to set or change parameters initial values for parameters for a particular component may be set either by a slider, a text entry or a checkbox.

Referring to FIG. 12, a display 200 is shown which depicts an example of the tasking center. On this display each tab 202 represents a task.

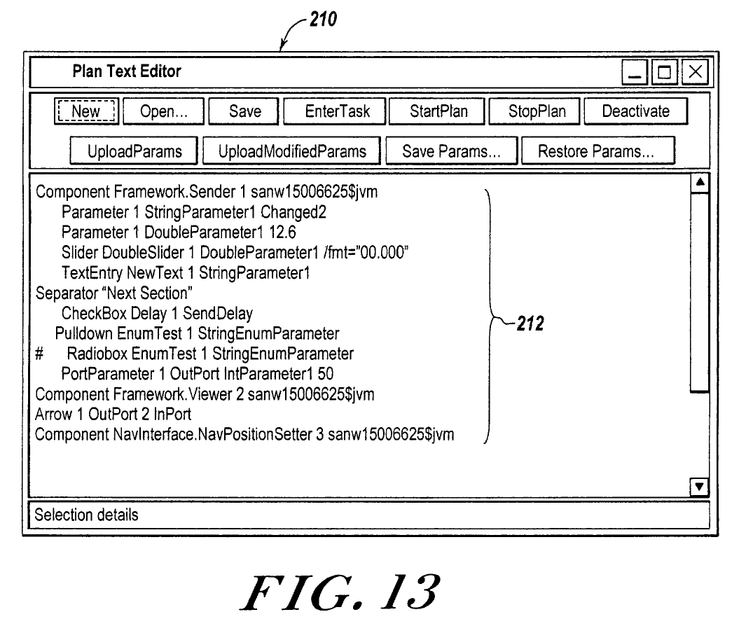

Referring to FIG. 13, a display 210 is shown which is an example of the Plan Text Editor. This display allows the user to create an ad hoc plan by using scripting commands 212. Each line item represents a unique command. The first component describes a component entry in which the Component Sender which is ID number 1 is deployed on processor san15006625$jvm. The second line describes the initial setting for parameter 1. On that component the name is “String Parameter 1” and the value is changed. The other line represents GUI commands which will be shown in a later display.

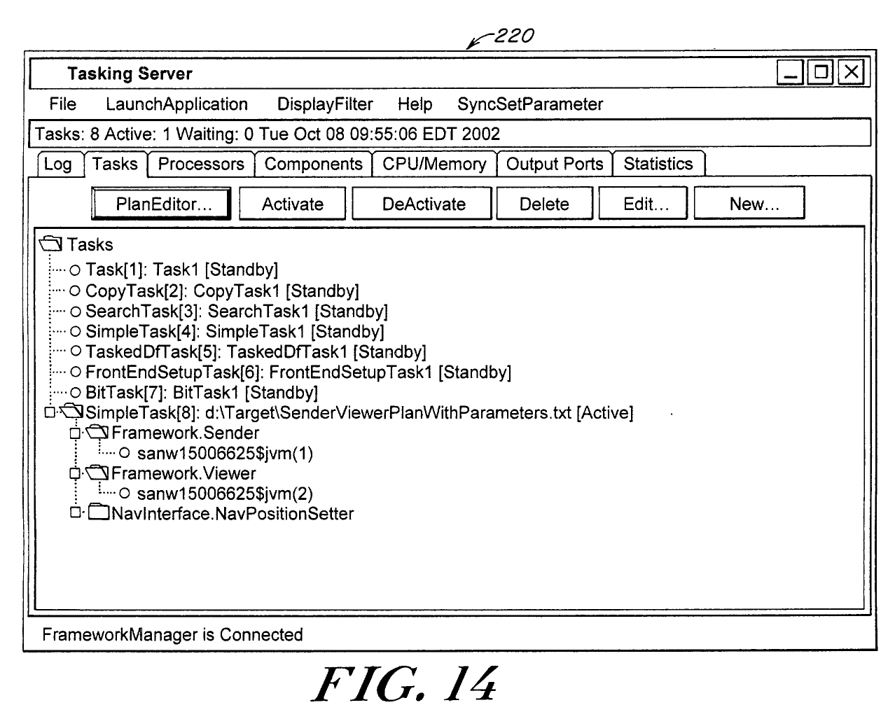

FIG. 14 shows the Tasking Server display 220. This display shows the simple task in the active state underneath the task name for all the component types. Underneath each component type are the instances of that component. In this example there is one sender component in one viewer component.

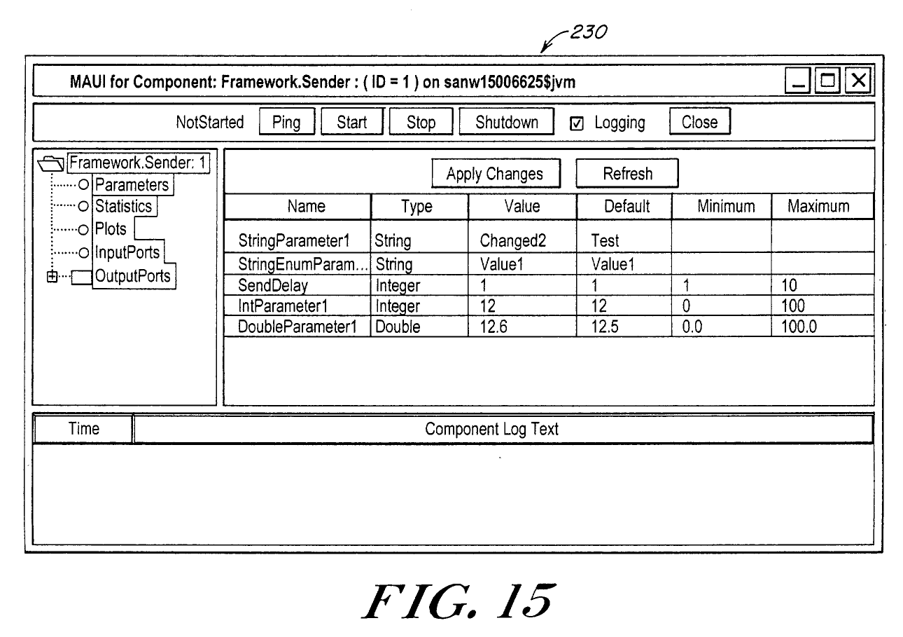

Referring to FIG. 15, a display 230 is shown which is the MAUI itself that is called up by clicking a component line. The form of this display as shown here had taken its information from the Framework Sender Component which is selected. What is shown in the display is the output framework. Here it is also shown that there are three parameters. Note that the first is a string parameter. A second is an integer parameter. And the last is a double parameter.

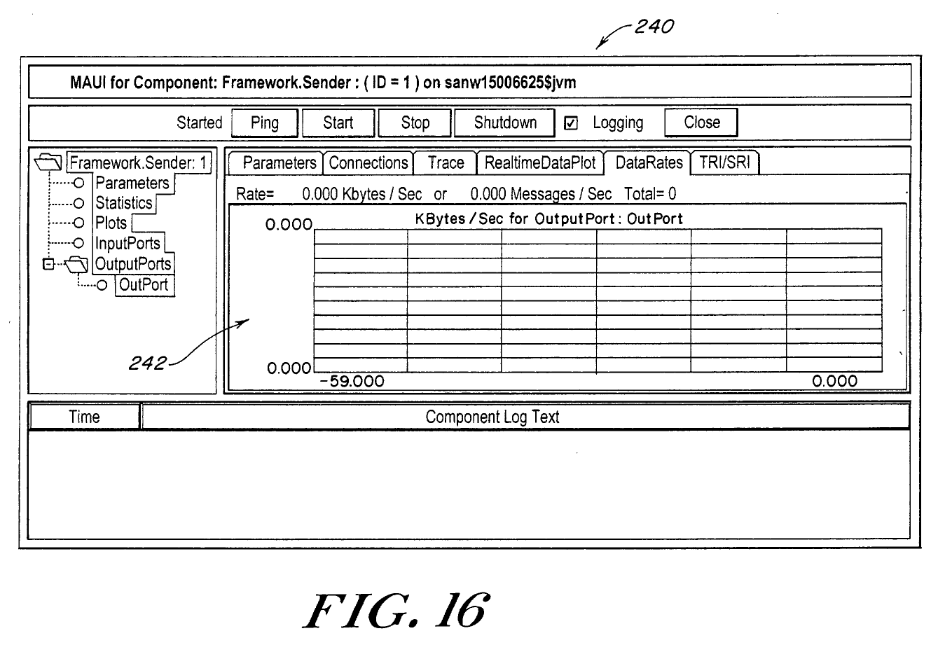

Referring to FIG. 16, a display 240 is shown which is the MAUI for each component. The output port is selected. The plot 242 shown here is the data rate for the data appearing on that output port.

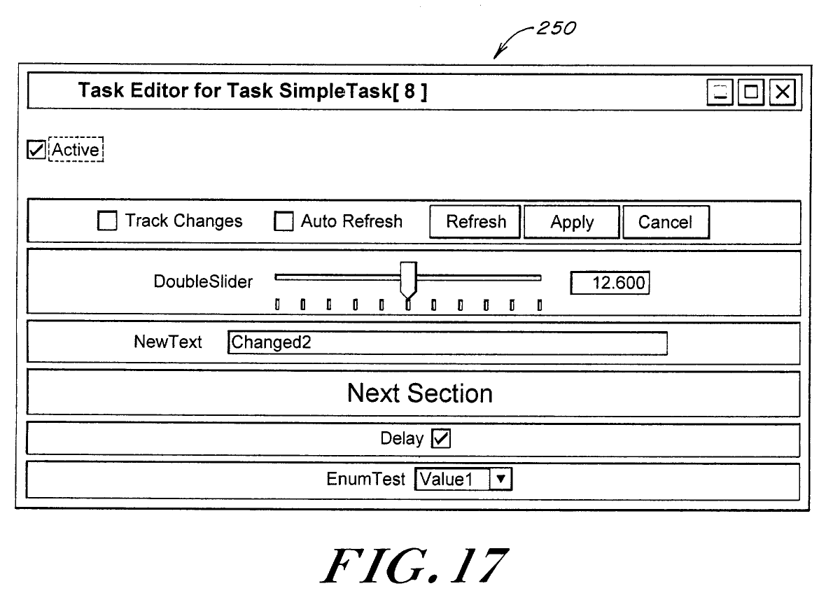

Referring to FIG. 17, a display 250 is shown which is a Task Editor for Task Simple Task is shown. This display is the custom display created from the Task Plan of a FIG. 14.

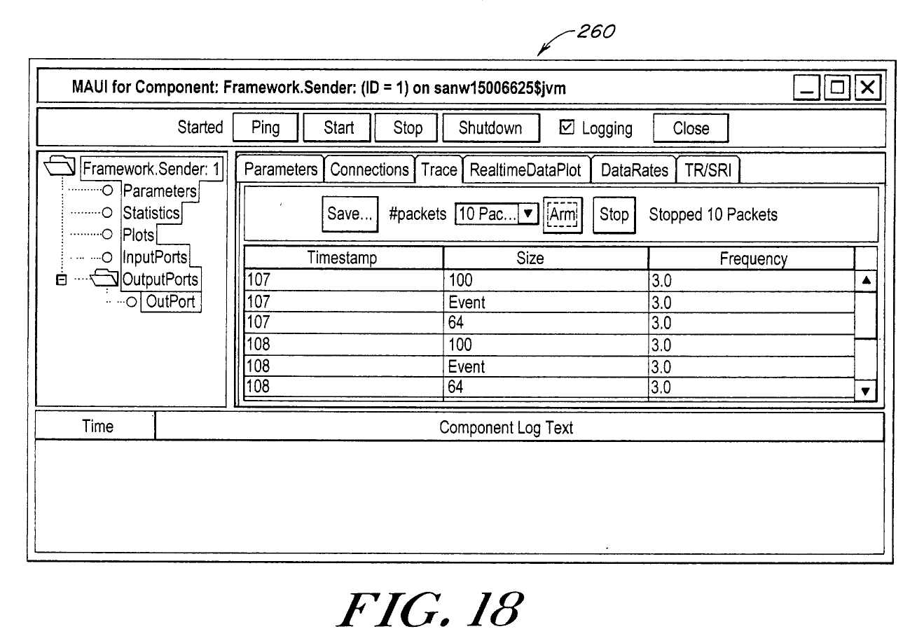

Referring to FIG. 18 a display 260 is shown that displays data that was captured flowing between the sender and the viewer. The component captured here included ten packets. Each packet is listed by one of the lines on the display. The user can double click a line and the display will show the details of that packet.

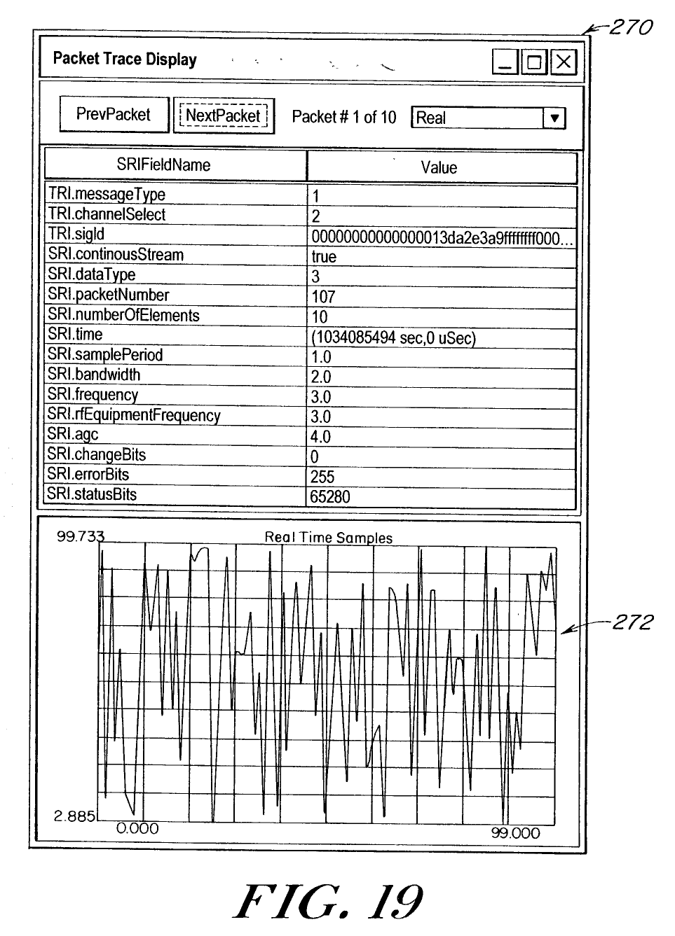

Referring to FIG. 19, a display 270 shows the packet details for the first packet captured on the display of FIG. 18. Shown on the top are the signal related details, and on the bottom, the actual data itself as a plot 272.

The source code used in a preferred embodiment of this invention is presented in the Appendix thereto.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for operating a system having a plurality of components comprising the steps of:
attaching a control means to one of said components of the system;
and causing said control means to configure itself based on information derived from said component;

2. The method of claim 1, wherein the control means has a parameters display and said parameter display is configured based on parameters discovered from the component

3. The method of claim 1, wherein the control means has a plot menu and said plot menu is selected based on plots indicated to be present in the component.

4. The method of claim 1, wherein the control means has statistics and said statistics are populated based on statistics indicated to be present in the component.

5. The method of claim 1, wherein the control means is adapted to capture output data generated by a component and display the data in a predetermined format.

6. The method of claim 1, wherein the control means interrogates the components connections and navigates to the connected component.

7. Apparatus for observing the operation of a system having a plurality of software components, comprising:
an observation tool adapted to observe the operation of a component;
an application for coupling said observation tool to a preselected software component for monitoring a predetermined function thereof; and,
a display for visually presenting a representation of the monitored function.

8. The apparatus of claim 7, wherein said predetermined function includes parameters of said preselected software component, and wherein said display presents the monitored parameters.

9. The apparatus of claim 8, wherein said monitoring application queries said preselected component to discover the parameters associated with said preselected software component.

10. The apparatus of claim 7, wherein said observation tool includes a plot function and wherein said display presents a plot of said monitored function.

11. The apparatus of claim 7, wherein said observation tool includes means for gathering statistics based on the operation of said preselected software component.

12. The apparatus of claim 11, wherein said monitoring application queries said predetermined software component to ascertain what statistics are available thereat.

13. The apparatus of claim 7, wherein said observation tool includes means for capturing output data from said preselected software component and wherein said display presents the captured output data in a predetermined format.

14. The apparatus of claim 7, and further including an interrogator coupled to said observation tool for interrogating the connections associated with said components and for causing said observation tool to navigate to said preselected software component.
